(19) United States
(12) Patent Application Publication
(10) Pub. No.: US 2002/0179730 A1
(43) Pub. Date: Dec. 5, 2002

(54) Fuel injection device for internal combustion engines

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/049,678

(22) PCT Filed: Jun. 12, 2001
(86) PCT No.: PCT/DE01/02181

(30) Foreign Application Priority Data
Jun. 15, 2000 (DE) 100 29 629.7

(51) Int. Cl. F02M 47/02

(52) U.S. Cl. 239/88

(57) ABSTRACT

A fuel injection device (1) for internal combustion engines, with an injection nozzle that can be supplied with fuel from a high-pressure fuel source (8) and with an actuating element (9) that opens and closes the injection nozzle as a function of the pressure in control chamber (6) is proposed. A high-pressure line (7) discharges into the control chamber (6), and an outflow conduit (10) leads away from the control chamber (6) and can be blocked by a closing element (13) of a valve member (3). A high-pressure delivery system (19, 20, 21, 22) that leads into a nozzle chamber can be blocked by a first valve seat (4) of the valve member (3), and the valve member (3) is movable by a defined stroke length by means of an actuator (2). As a function of this stroke length, the closing element (13) is movable between a closing position and an opening position, the latter relieving the control chamber (6) and allowing an injection (Drawing).

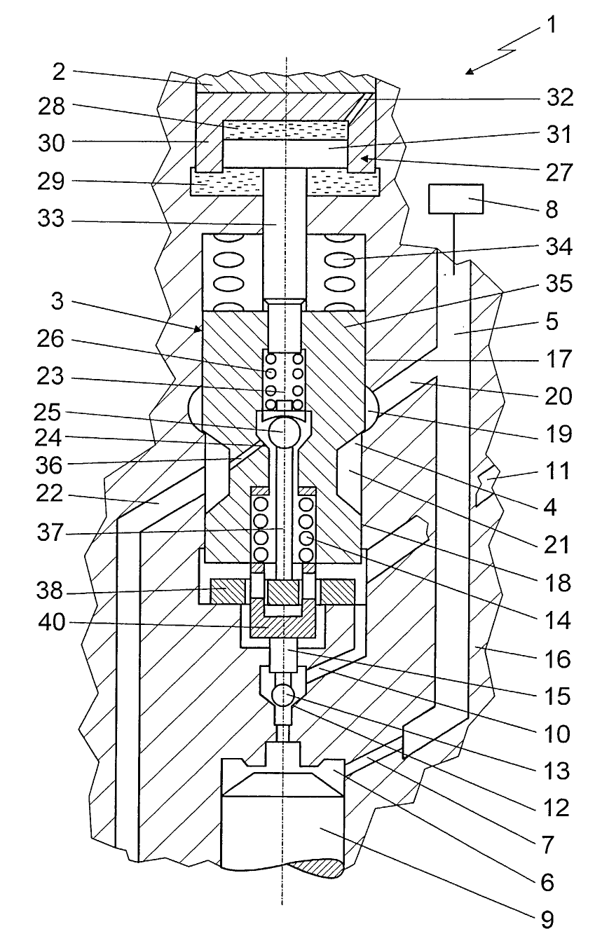

### Prior Art

The invention is based on fuel injection devices for internal combustion engines, which are well known in the industry and in which fuel from a high-pressure fuel source is delivered to a nozzle chamber via a control valve in the opening position of a valve member. The fuel delivered to the nozzle chamber at high pressure is injected into a combustion chamber of an internal combustion engine via an injection opening when a nozzle in open. The delivery of fuel to the injection opening is frequently controlled via the control valve, embodied as a slide valve or seat-slide valve, which can be embodied as either force-balanced or partially force-balanced.

The use of such control valves has the disadvantage, however, that to open and close supply and discharge lines for the fuel that is at high pressure, control edges are provided that typically have small overlaps, which in turn leads to major leakage flows in the control valve. Hence only an inadequately uniform opening pressure can be established in the control valve.

To overcome these disadvantages, a transition has been made to the use of injection valves and in particular double-seat valves, which compared with slide valves have the advantage that the stroke length can be markedly increased, and a forceful sealing action at the seats is attainable. It has furthermore been ascertained in experiments that the stroke length, for instance in a double-seat valve, can be selected as so short that direct triggering of the valve can be done by an actuator, which is embodied for instance as a piezoelectric control unit.

Such double-seat valves known in the industry make the opening pressure for the nozzle available via a stroke-controlled system in such a way that at a certain position of the valve member of the control valve, a nozzle chamber is subjected to high pressure, which causes opening of the nozzle.

It is disadvantageous, however, that from the time the nozzle opening pressure is released, the nozzle can be closed again only with great difficulty, since in the opening position of the valve member, the nozzle is constantly subjected to high pressure or to its opening pressure and can accordingly no longer be actively triggered in order to close the control valve and then open it again, for instance for performing a postinjection.

### ADVANTAGES OF THE INVENTION

The fuel injection device of the invention having the characteristics of claim 1 has the advantage over the prior art that it is equipped with a combined pressure- and stroke-controlled system, by means of which the nozzle is actively controllable, and a postinjection can be performed in a simple way.

A further advantage of the fuel injection device of the invention is that the pressure buildup has a shallower course and is thus slower; as a result, the injection quantity is less, and a delayed closure of the kind that occurs in a purely pressure-controlled system is averted.

According to the invention, beyond a defined stroke length of the valve member, fuel delivered at high pressure can be diverted from the control chamber, and as a result the nozzle is opened under pressure control. Upon a decrease in the stroke below this predefined stroke of the valve member, high pressure prevails in the control chamber again, since as a function of the stroke length of the valve member, the closing element is movable from an opening position, which relieves the control chamber and allows an injection, into a closing position. The nozzle is then closed, even though the first valve seat is still open and high pressure still prevails in the nozzle chamber.

Thus the injection of fuel is advantageously terminated under stroke control on the one hand, and on the other hand, high pressure for a postinjection that may possibly ensue after the main injection still prevails in the nozzle chamber.

Thus the nozzle can be controlled quickly and without delay under stroke control, and as a result the development of smoke is also advantageously averted. Furthermore, by means of a late injection, the proportion of hydrocarbon in the engine exhaust gas can be reduced considerably.

A desired second, subsequent injection can be executed in the fuel injection device of the invention by increasing the stroke of the valve member beyond the predefined stroke length. If immediately subsequent to that the first valve seat is closed again by means of the valve member, then the delivery of fuel at high pressure to the nozzle chamber is interrupted. While the high-pressure delivery system is relieved beyond the first valve seat, high pressure, which assures a closed nozzle, prevails in the control chamber.

Further advantages and advantageous features of the invention will become apparent from the claims and from the ensuing exemplary embodiment described in principle in conjunction with the drawing.

### DRAWING

In the drawing, one exemplary embodiment of the invention is shown, which is explained in further detail in the ensuing description. The sole drawing FIGURE is a schematic illustration of a fuel injection device according to the invention for internal combustion engines, in which a valve member is disposed in a high-pressure delivery system to a nozzle chamber of the fuel injection device.

### DESCRIPTION OF THE EXEMPLARY EMBODIMENT

The exemplary embodiment shown in the drawing shows a fuel injection device 1 in simplified form, with an actuator 2 that is operatively connected to a valve member 3. This valve member 3 is disposed in a high-pressure delivery system of the fuel injection device 1, which connects a high-pressure fuel source 8 to a nozzle chamber, not shown in detail of an injection nozzle, leading into a combustion chamber of an internal combustion engine of the motor vehicle. For displacement of the valve member 3 in a valve housing 16, an actuator 2 is provided, by means of which the valve member 3 is triggerable in such a way that it can be lifted from a first valve seat 4.

When the valve member 3 is in contact with the first valve seat 4, it disconnects the nozzle chamber from the high-pressure fuel source 8 of the fuel injection device 1. In this position of the valve member 3, no high pressure prevails in the nozzle chamber, and the injection nozzle is closed. A control chamber 6 is constantly supplied with fuel at high pressure via a first high-pressure line 7 from the high-pressure fuel source, embodied as a common rail system 8, and thus an actuating element 9, which defines the control chamber 6 and is axially displaceable in it, is subjected to this high pressure.

The actuating element 9, which is also called a valve needle, extends into the nozzle chamber, and via the actuating element 9, the control chamber 6 is operatively connected to the nozzle in such a way that upon the application of high pressure in the control chamber 6, the nozzle is kept in the closing position by the actuating element 9.

The control chamber 6 communicates via an outflow conduit 10 with a first leakage-fuel bore 11, by way of which fuel that is at high pressure can be diverted from the control chamber 6. This outflow conduit 10 is closable to prevent the flow through it of fuel via a spherically embodied closing element 13 that cooperates with a second valve seat 12.

A spring element 14, which is braced by its end remote from the closing element 13 on the valve member 3, exerts a spring force, in accordance with its prestressing, via an intermediate part 15, that acts in the direction of the second valve seat 12 on the closing element 13. The intermediate part 15 is guided displaceably in the valve housing 16 coaxially to the valve member 3.

In a region between a first guide 17 of the valve member 3, toward the actuator, and a second guide 18 of the valve member 3, provided in the region of the end remote from the actuator 2 of the valve member 3, an annular chamber 19 of the high-pressure delivery system is provided in the valve housing 16 around the valve member 3; a second high-pressure line 20 discharges into this annular chamber.

The annular chamber 19 is adjoined by a recess 21 of the valve member 3; when the first valve seat 4 is closed, the annular chamber 19 and the recess 21 are disconnected from one another, and a further high-pressure line 22 of the high-pressure delivery system branches off in the region of the recess 21 and leads to the nozzle chamber.

The valve member 3 is also provided with a central bore 23, in which a third valve seat 24 is embodied. The latter is closable with a spherical closure element 25. The third valve seat 24 is located between the second valve seat 12 and the end toward the actuator of the valve member 3, and it controls a pressure fluid connection from the recess 21 to the leakage-fuel bore 11. This pressure fluid connection is embodied here as a conduit 36 extending obliquely in the valve member 3. For actuation of the closure element 25, a tappet 37 is used, and a second spring element 26 acts counter to the tappet. This second spring element is braced by its end remote from the closure element 25 on the valve member 3.

A tappet 37 contacting the closure element 25 extends coaxially to the valve member 3 in the direction of the control chamber 6. With its end toward the control chamber, the tappet 37 contacts a platelike disk 38, which is fixed on a shoulder in the interior of the valve housing 16. The disk 38 has openings, through which extensions of a bridge member 40 protrude that extend in the direction of the valve member 3. The spring element 14 is braced on the end of these extensions. The opposite end, toward the control chamber, of the bridge member 40 is operatively connected to the intermediate part 15. The latter is placed essentially centrally to the longitudinal axis of the valve member 3 and carries the force of the spring element 14 on to the closing element 13. As a result, in the basic position shown for the fuel injection device 1, the closing element 13 is kept in the closing position despite the high pressure in the control chamber 6.

The actuator is embodied as a piezoelectric control unit 2 and is disposed on the side of the valve member 3 remote from the control chamber 6. Between the piezoelectric control unit 2 and the valve member 3, a reversal booster 27 is provided, which has a first hydraulic chamber 28, a second hydraulic chamber 29, and an adjusting element 30 of U-shaped cross section that is open on its end remote from the piezoelectric control unit 2.

An end 31, embodied in platelike fashion, of the valve member 3 in pistonlike fashion engages the inside of the adjusting element 30, disposed between the piezoelectric control unit 2 and the valve member 3; the first hydraulic chamber 28 is defined by the adjusting element 30 and the platelike end 31 of the valve member 3. The second hydraulic chamber 29 is provided on the side of the platelike end 31 remote from the first hydraulic chamber 28; the second hydraulic chamber 29 is defined by the valve housing 16, the adjusting element 30 and the valve member 3 and is embodied as a closed system.

The adjusting element 30 has a leakage-fuel bore 32 discharging into the first hydraulic chamber 28 and with its open end engages the inside of the second hydraulic chamber 29 in such a way that a spacing between the adjusting element 30 and the valve member 3, or the platelike end 31 of the valve member 3, upon an actuation of the piezoelectric control unit 2 decreases.

The actuation of the piezoelectric control unit 2 is brought about in a manner known per se by means of a precisely defined voltage applied to the piezoelectric ceramic of the piezoelectric control unit 2 and causes a stroke of the valve member 3 in accordance with the applied voltage.

For assembly reasons, the valve member 3 in the version shown is embodied in multiple parts, in such a way that the platelike end 31 of the valve member 3 is connected, via a boltlike connecting part 33 of smaller diameter, which is guided in the valve housing 13, to a base body 35 of the valve member 3 that in the nontriggered state of the piezoelectric control unit 2 closes the first valve seat 4; in this case, the connecting part 33 is screwed into the base body 35.

It is understood that it is up to the judgment of one skilled in the art, instead of a screw fastening, to provide some other suitable way of making a connection between the boltlike connecting part 33 and the base body 35 of the valve member 3, such as a press fit, and adhesive bond, or the like.

Between the end toward the actuator of the base body 35 of the valve member 3 and the housing 16, a further spring element 34 is provided, counter to whose spring force the valve member 3 can be lifted from the valve seat 4; in the nontriggered state of the piezoelectric control unit 2, the valve member 3 is kept in contact with the first valve seat 4 by the further spring element 34.

The fuel injection device 1 in accordance with the drawing functions as described below.

In the nontriggered state, shown, of the piezoelectric control unit 2, the valve member 3 is in contact with the first valve seat 4. The delivery of fuel, which takes place from the common rail system 8 at high pressure to the nozzle chamber via the high-pressure delivery system, or in other words the high-pressure line 20, the annular chamber 19, the recess 21 and the further high-pressure line 22, is interrupted by the valve member 3 upon contact with the first valve seat 4. By the prestressing of the second spring element 14, the closing element 34 is pressed against the second valve seat 12, so that the outflow conduit 10 is blocked off by it from the control chamber 6. In the control chamber 6, via the first high-pressure line 7, which establishes a communication between the control chamber 6 and the common rail system 8, high pressure prevails, which acts on the actuating element 9 in such a way that the nozzle is closed. The third valve seat 24 is opened, since the tappet 37, because of its length, lifts the closure element 25.

If an electrical voltage is applied to the piezoelectric control unit 2, the result is a change in length in the piezoelectric ceramic, which is transmitted to the adjusting element 30. The adjusting element 30, which with its open end engages the inside of the second hydraulic chamber 29, increasingly plunges into an incompressible fluid provided in the second hydraulic chamber 29. As a result, a force is exerted on the side remote from the actuator of the platelike end 31 of the valve member 3. This force in turn acts on a fluid located in the first hydraulic chamber 28, which flows out of the first hydraulic chamber 28 via the leakage-fuel bore 32 of the adjusting element 30. Thus by an actuation of the piezoelectric control unit 2, the valve member 3 is displaced away from the first valve seat 4 in the direction of the piezoelectric control unit 2 by a certain adjustment length or stroke length axially in the valve housing 16, and the valve member 3 lifts from the first valve seat 4. Since with the lifting of the valve member 3 from the first valve seat 4 the communication between the common rail system 8 and the nozzle chamber is opened by the valve member 3, the nozzle chamber is subjected to high pressure.

Beyond a precisely defined adjustment length or stroke length of the valve member 3, a prestressing force of the second spring element 14 is reduced in such a way that the closing element 13 is lifted from the second valve seat 12 as a result of the high pressure prevailing in the control chamber 6. The fuel delivered to the control chamber 6 at high pressure is removed from the control chamber 6 via the outflow conduit 10 and flows out of the housing 16 via the leakage-fuel bore 11. The pressure in the control chamber 6 is thus reduced, and because of the pressure difference between the nozzle chamber and the control chamber 6, the actuating element 9 is displaced in the direction of the control chamber 6, which causes the nozzle to open.

In this first stage, the valve member 3 is displaced by the maximum stroke, and at the same time the closure element 25 closes the third valve seat 24. In the high-pressure line 22, high pressure builds up, since the pressure fluid connection of the recess 21 to the leakage-fuel bore 11 is blocked via the third valve seat 24. The fuel injection device 1 and the nozzle, in this position of the valve member, are opened because of the applied high pressure.

When the valve member 3 is then, in a second stage, moved back in the direction of the first valve seat 4 by approximately half the maximum stroke, the fuel injection device 1 and the nozzle are closed via this stroke control, since because of the spring prestressing of the spring element 14, the closing element 13 is pressed against the second valve seat 12 counter to the high pressure of the control chamber 6, and high pressure again prevails in the control chamber 6 itself. The high pressure prevailing in the control chamber 6 displaces the actuating element 9 in the direction of the nozzle chamber, and as a result the nozzle is closed. The third valve seat 24 remains closed, since the length of the tappet 37 does not suffice to lift the closure element 25 from the third valve seat 24. Thus the high pressure level in the high-pressure line 22 persists.

To achieve an ensuing postinjection after the first injection, the valve member 3 in a third phase is displaced again by the maximum stroke, and the nozzle is reopened, since the second valve seat is again opened in the manner described.

For terminating the postinjection, the fuel injection device 1 is relieved of the fuel delivered at high pressure; this is accomplished in that, in a fourth phase, the first valve seat 4 is closed and the third valve seat 24 is opened by the closure element 25, and thus the fuel is carried away via the leakage-fuel bore 11.

The various positions of the valve member 3 in the four phases described above are achieved by way of voltages at various levels that are applied to the piezoelectric control unit 2. When the valve member 3 is in contact with the first valve seat 4, no voltage is applied to the piezoelectric control unit 2, or only such a slight voltage that a flow of fuel at high pressure through it to the nozzle chamber is reliably interrupted.

The spring elements 14, 26, 34 are embodied in the present exemplary embodiment as helical springs, as shown in the drawing. However, it is understood that it is up to the judgment of one skilled in the art to provide other versions of spring elements suited to the particular application, such as cup spring assemblies or the like.

The possibility furthermore exists of making the high pressure for the fuel injection device available via a high-pressure fuel source that supplies only a single nozzle at a time with high pressure.

1. A fuel injection device (1) for internal combustion engines, having an injection nozzle that can be supplied with fuel from a high-pressure fuel source (8) and an actuating element that opens and closes the injection nozzle as a function of the pressure in a control chamber (6), a high-pressure line (7) that discharges into the control chamber (6), an outflow conduit (10) that originates at the control chamber (6) and is closable by a closing element (13) of a valve member (3), and having a high-pressure delivery system (19, 20, 21, 22), leading into a nozzle chamber, which high-pressure delivery system can be blocked by a first valve seat (4) of the valve member (3), wherein the valve member (3) is movable by a defined stroke length by means of an actuator (2), as a function of which stroke length the closing element (13) is movable between a closing position and an opening position that relieves the control chamber (6) and allows an injection.

2. The fuel injection device of claim 1, characterized in that when the first valve seat (4) is open and in the opening position of the closing element (13), an injection takes place, and when the first valve seat (4) is open and the closing element (13) is in the closing position, no injection takes place.

3. The fuel injection device of claim 1 or 2, characterized in that the closing element (13), upon application of high pressure in the control chamber (6) and at a defined stroke of the valve member (3), lifts from a second valve seat (12) assigned to it, counter to a spring force of a spring element (14) that is braced on the valve member (3).

4. The fuel injection device of one of claims 1-3, characterized in that in a region between a first guide (17) of the valve member (3), toward the actuator, and a second guide (18) of the valve member (3), provided in the region of the end remote from the actuator (2) of the valve member (3), an annular chamber (19) around the valve member (3) is provided, into which a high-pressure line (20) of the high-pressure delivery system (19, 20, 21, 22) discharges.

5. The fuel injection device of claim 4, characterized in that a recess (21) of the valve member (3) adjoins the annular chamber (19), and the annular chamber (19) and the recess (21) are separated from one another when the first valve seat (4) is closed, and in the region of the recess (21) a further high-pressure line (22) of the high-pressure delivery system (19, 20, 21, 22) branches off and leads to the nozzle chamber.

6. The fuel injection device of one of claims 1-5, characterized in that the valve member (3) has a central bore (23), in which a third valve seat (3) is embodied, which cooperates with an at least approximately spherical closure element (25).

7. The fuel injection device of claim 6, characterized in that the closure element (25) is pressed via a further spring element (26), which is braced on the valve member (3), against the third valve seat (24), and the third valve seat (24) is opened, in the non-triggered state of the valve member (3), at a pressure difference which is greater than the spring force of the third spring element (26).

8. The fuel injection device of one of claims 1-7, characterized in that the actuator (2) is disposed on the side of the valve member (3) remote from the control chamber (6).

9. The fuel injection device of one of claims 1-8, characterized in that between the actuator (2) and the valve member (3), a reversal booster (27) is provided, which has a first hydraulic chamber (28), a second hydraulic chamber (29), and an adjusting element (30), of U-shaped cross section, that is open on its end remote from the actuator (2).

10. The fuel injection device of claim 9, characterized in that an end (31) of the valve member (3), embodied in platelike shape, engages the inside of the adjusting element (30) disposed between the actuator (2) and the valve member (3), and the first hydraulic chamber (28) is defined by the adjusting element (30) and the platelike end (31) of the valve member (3), and the second hydraulic chamber (29) is provided on the side of the platelike end (31) remote from the first hydraulic chamber (28).

11. The fuel injection device of claim 9 or 10, characterized in that the adjusting element (30) has a leakage-fuel bore (32) discharging into the first hydraulic chamber (28), and with its open end it engages the inside of the second hydraulic chamber (29), in such a way that a spacing between the adjusting element (30) and the valve member (3) decreases upon an actuation of the actuator (2).

12. The fuel injection device of one of claims 1-11, characterized in that the actuator (2) is embodied as a piezoelectric control unit (2).

13. The fuel injection device of one of claims 1-12, characterized in that the high-pressure fuel source is embodied as a common rail system (8).
